(19) United States
(12) Patent Application Publication
(10) Pub. No.: US 2019/0186704 A1
(43) Pub. Date: Jun. 20, 2019

(54) SOLAR-POWERED DECORATIVE LIGHT SYSTEM, DECORATIVE LIGHT APPARATUS, AND A METHOD OF CONTROLLING A DECORATIVE LIGHT APPARATUS

(71) Applicant: Evergreen Enterprises of Virginia, LLC, Richmond, VA (US)

(72) Inventors: Fei Qiu, Richmond, VA (US); Guo dong Zheng, Ningbo (CN)

(21) Appl. No.: 16/218,956

(22) Filed: Dec. 13, 2018

Related U.S. Application Data
(60) Provisional application No. 62/599,389, filed on Dec. 15, 2017.

(51) Int. Cl. F21S 9/03; F21V 21/08; H05B 37/02; H05B 33/08

(52) U.S. Cl. CPC F21S 9/035; F21V 21/0824; F21W 2121/00; H05B 33/0857; H05B 37/0209

(57) ABSTRACT

A solar-powered decorative light system, a decorative light apparatus, and a method of controlling a decorative light apparatus. The solar-powered light system includes kinetic, balancing decorative items having controllable light sources that illuminate to give a “chasing light” visual effect that is automatically illuminated in response to movement of the decorative items. The illumination of the light sources is configured to correlate or is otherwise synchronized in relation to movement of the decorative items.

### CROSS-REFERENCE TO RELATED APPLICATIONS

The present application claims priority to U.S. Provisional Patent Publication No. 62/510,543 (filed on May 24, 2017), which is hereby incorporated by reference in its entirety.

### FIELD OF THE INVENTION

Embodiments relate to a solar-powered decorative light system, a decorative light apparatus, and a method of controlling a decorative light apparatus.

### BACKGROUND

Solar-powered decor enhances outdoor spaces and eliminates the need for plugging the item in to a separate electrical source, such as a power outlet. Existing solar powered outdoor decor comes in a variety of forms, from garden stakes to lanterns to hanging mobiles. Garden stakes specifically also come in a variety of forms, and often include solar powered illuminating features and/or kinetic features that move in response to wind or someone touching the moving feature of the stake. The decorative garden stakes that feature both solar powered lighting and a kinetic feature do not combine the two elements in a way that permits the elements to work together. Rather, the illuminating feature is independent of the movement of the kinetic feature of the garden stake.

There are existing solar-powered outdoor decor that have moveable functionality. There is a need, however, for a kinetic, solar powered outdoor decor piece with an illuminating feature that is automatically activated by and moves in response to the movement of the decorative luminaries.

### SUMMARY

Embodiments provides for a solar-powered decorative light system, a decorative light apparatus, and a method of controlling a decorative light apparatus. The solar-powered light system comprises kinetic, balancing decorative items having controllable light sources that illuminate to give a “chasing light” visual effect that is automatically illuminated in response to movement of the decorative items. The illumination of the light sources is configured to correlate or is otherwise synchronized in relation to movement of the decorative items.

### DRAWINGS

Embodiments will be illustrated by way of example in the drawings and explained in the description hereinbelow.

FIG. 1 illustrates a perspective view of a decorative light system, in which a light apparatus is in a balanced operating state, in accordance with embodiments.

FIG. 2 illustrates a side view of the decorative light system of FIG. 1.

FIG. 3 illustrates a side view of the decorative light system of FIG. 1, with the light apparatus is in an off-balanced operating state.

FIG. 4 illustrates a top view of the power module assembly for the decorative light system, in accordance with embodiments.

FIG. 5 illustrates an exploded view of the decorative light system, in accordance with embodiments.

FIG. 6 illustrates a side view of the power module assembly for the decorative light system, in accordance with embodiments.

FIG. 7 illustrates a bottom view of the power module assembly for the decorative light system, in accordance with embodiments.

FIG. 8 illustrates a side view of the decorative light system of FIG. 1, with the light apparatus in an off-balanced operating state and the illumination of light emitted therefrom.

FIG. 9 illustrates a diagram of a light apparatus for the decorative light system of FIG. 1.

FIG. 10 illustrates a diagram of a power module for the decorative light system of FIG. 1.

FIG. 11 illustrates a diagram of a decorative light module for the decorative light system of FIG. 1.

FIG. 12 illustrates a diagram of a control module for the decorative light system of FIG. 1.

FIG. 13 illustrates a block diagram of a method of controlling a light apparatus, in accordance with embodiments.

FIG. 14 illustrates a diagram of a light apparatus, in accordance with embodiments.

### DESCRIPTION

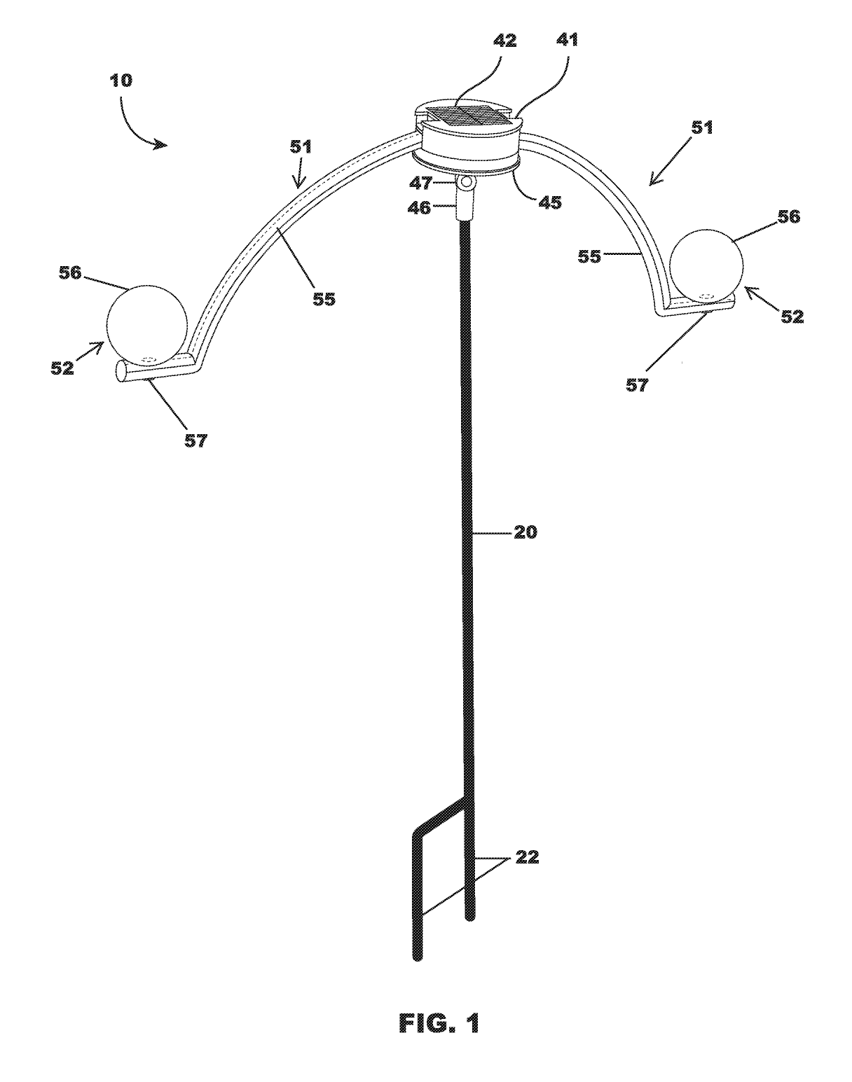

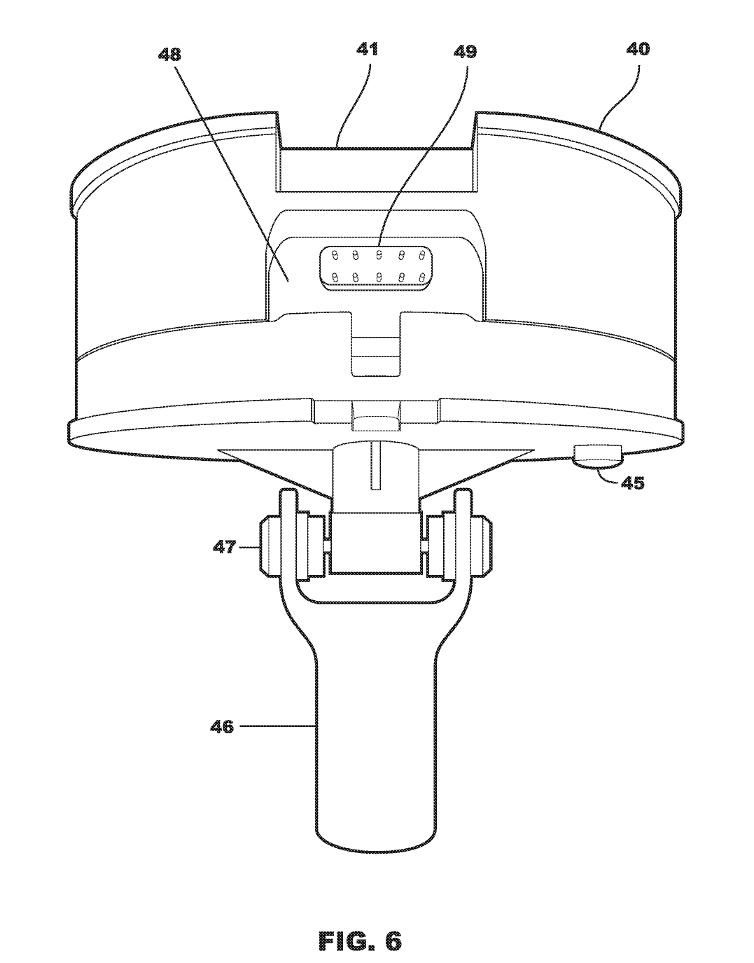

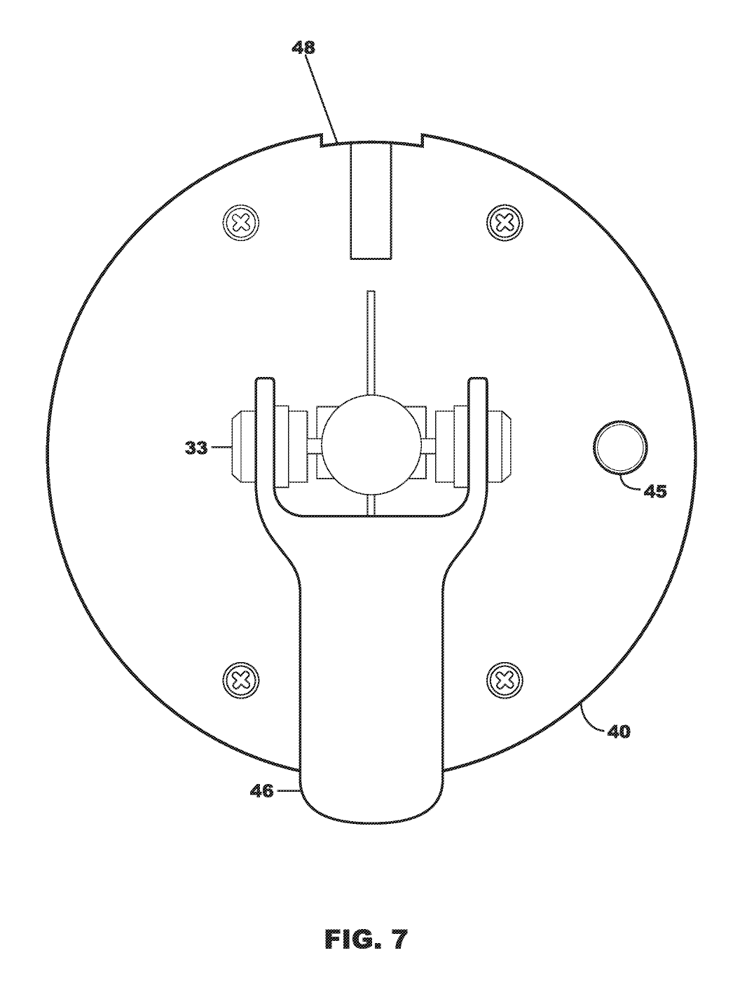

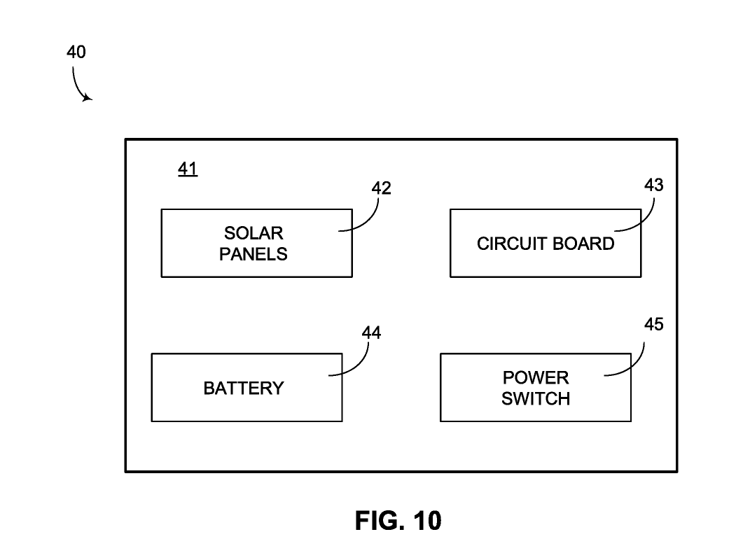

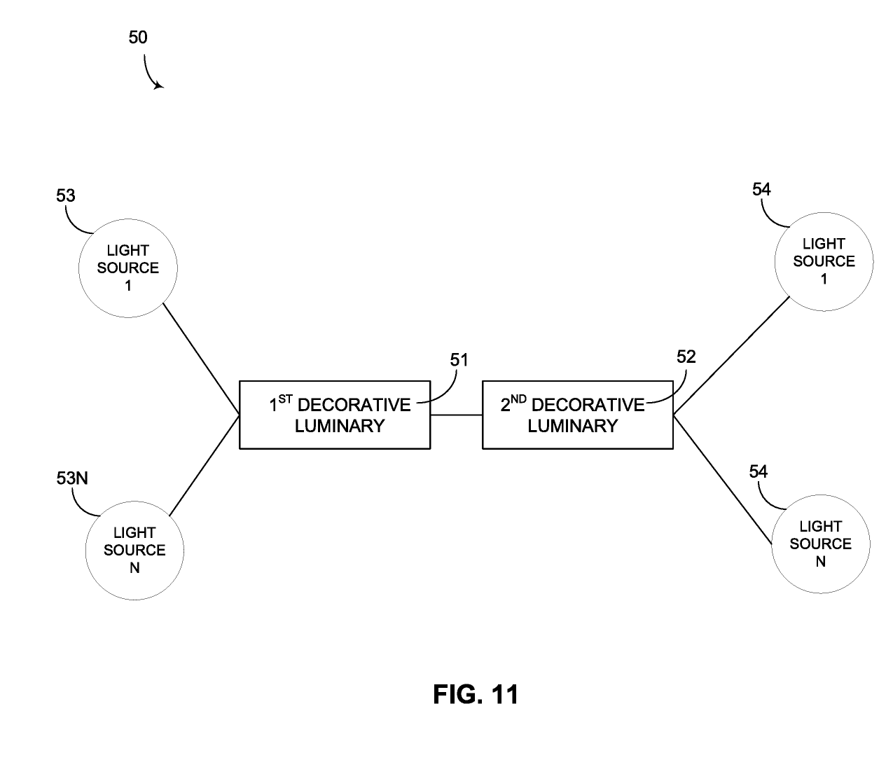

In the example illustrated in FIGS. 1 through 14, embodiments relate to a kinetic solar-powered balancer in the form of a decorative light system 10. The decorative light system 10 may comprise a support member 20 and a light apparatus 30 supported by the support member 20.

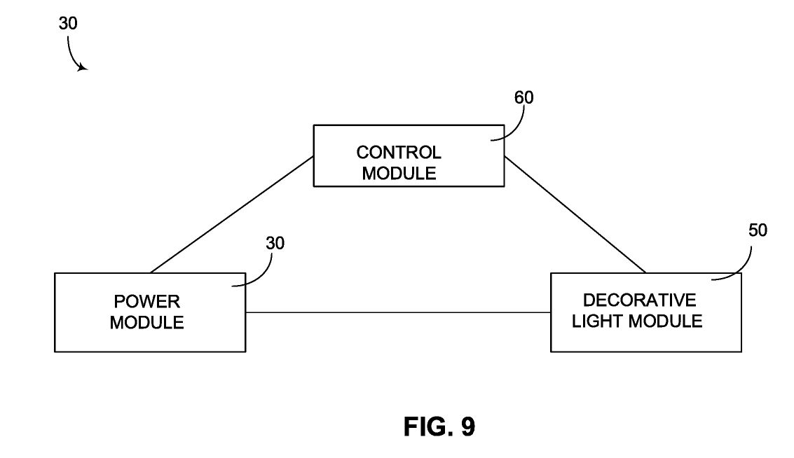

In the example illustrated in FIG. 9, the light apparatus 30 comprises a power module 40 supported by the support member 20, and decorative light module 50 powered by the power module to emit light, and a control module 60 to selectively control the decorative light module 50 via the power module 40.

In the example illustrated in FIGS. 1 through 3, the support member 20 has a proximal end 21 configured to support the power module 40, and a distal end 22 configured to support and permit the light system 10 in order that it stands upright on a support surface. For example, the distal end 22 may be inserted into the support surface (e.g., the ground outdoors) or otherwise rest on the support surface (e.g., the ground outdoors, flag pole, or stand, a table top, etc.). The distal end 22, for example, may include a base or anchor such as, for example, a two-point ground spike that may be driven into the support surface. Embodiments are not limited to such a spike, and thus, may encompass other anchoring devices such as, for example, other types of anchoring devices, such as a weighted base, anchor, four-point spike, and any other device that permits practice of the embodiments. The support surface may be a natural one that includes the ground of a lawn, garden or the like, or an artificial one that is to be placed on and/or over the lawn, garden or the like. Embodiments are not limited to support of the light system 10 on a support surface, and thus, may encompass other designs in which the kinetic solar balancer is suspended at a support point that lies above a ground surface.

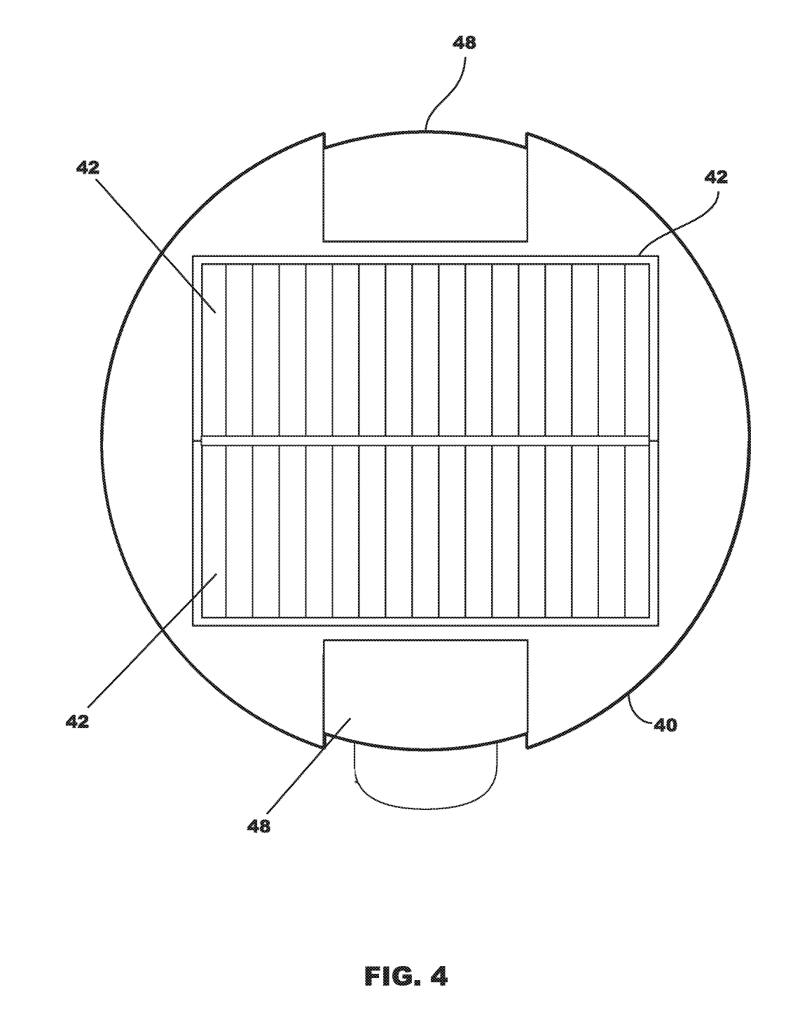

In the example illustrated in FIGS. 4 through 7 and 10, the power module 40 comprises a housing 41 that includes a power source having a solar circuit module with one or more solar panels 42, a circuit board 43, and a battery 44 such as, for example, a rechargeable battery, and a power switch 45 to activate and deactivate the light system 10. The solar panels 42 are configured to collect solar energy and power the decorative light module 50. Although the illustrated embodiments provide for a power source comprising a solar-circuit, embodiments are not limited thereto, and thus, may encompass other types of power sources that permit practice of the embodiments, such as for example, battery power source, and electrical power source, or an AC adapter.

Additionally or alternatively, the housing 41 may include a photosensor to detect ambient light. Such a photosensor may automatically trigger illumination of the light sources 53, 54 of the decorative light module 50 when ambient light falls below a predetermined level. The photosensor may trigger the illumination to cease when light levels are high. The power switch 45 may be used to start or intermittently halt the passage of electricity to the light sources 53, 54.

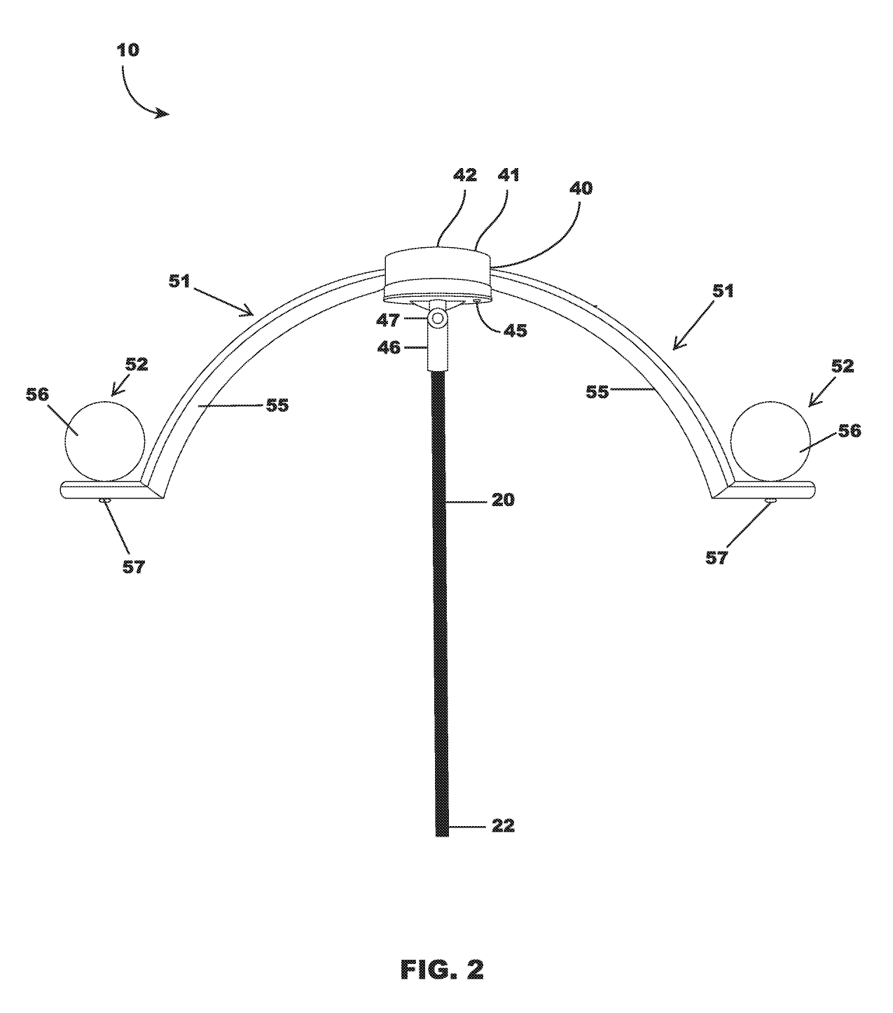

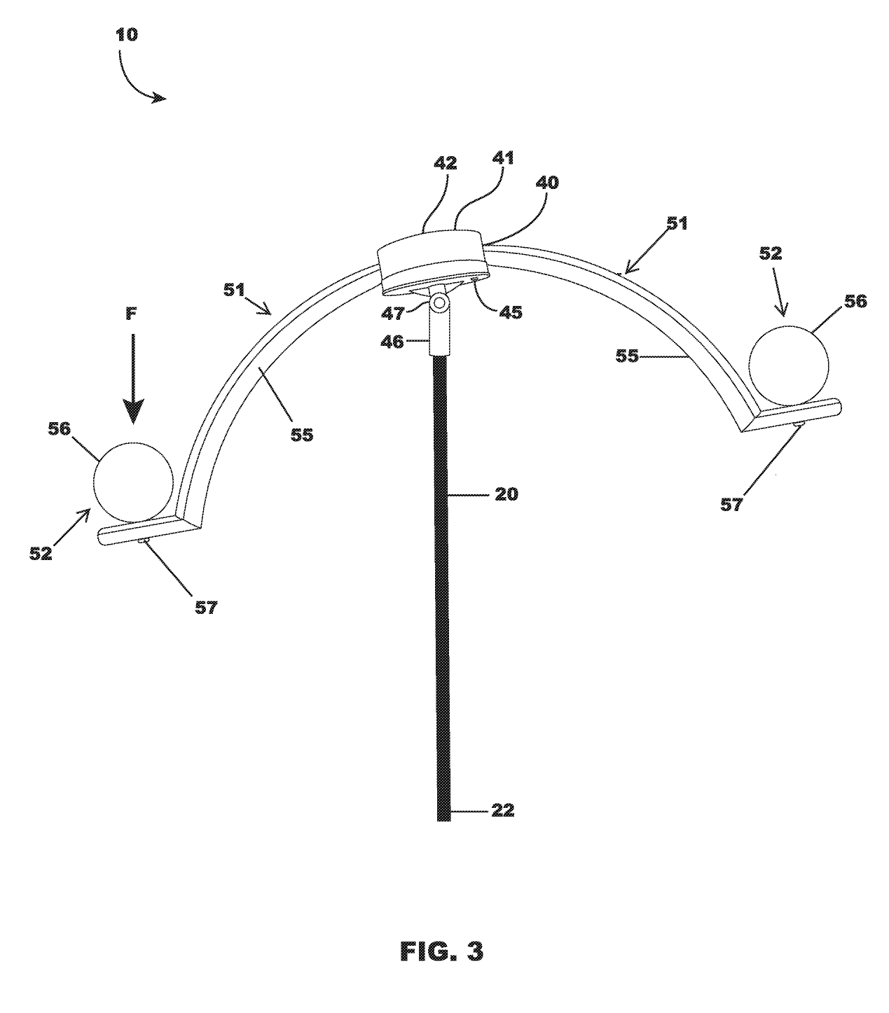

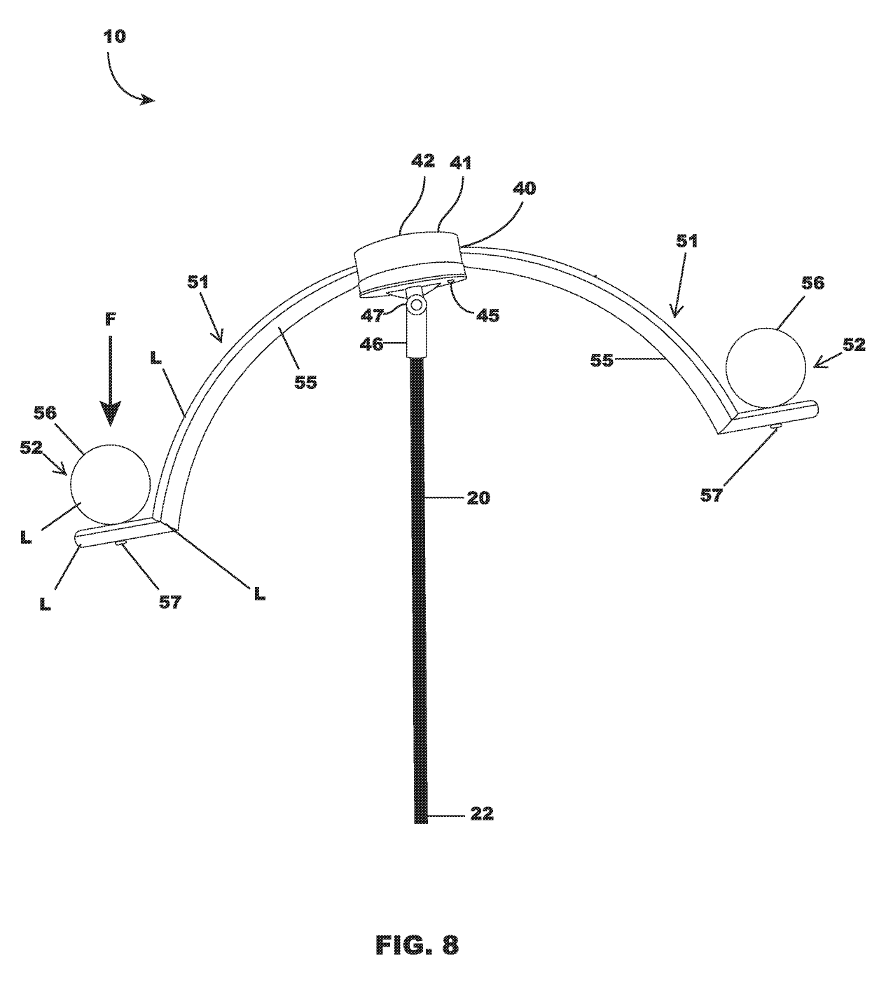

The power module 40 may be releasably connected to the support member 20 via a support sleeve 46. In accordance with embodiments, the support sleeve 46 may be removeably connected to the housing 41 at a connection point 47 defining a pivot axis that thereby facilitates movement of the power module 40 (and thus, the decorative light module 50) about the pivot axis between a stationary position (FIGS. 1 and 2) and a plurality of pivoting positions (FIGS. 3 and 8) relative to the support member 20. Such movement may occur, for example, when an outside force F (e.g., wind, touch of a person, etc.) is exerted on any relative component of the light system 10. Embodiments, however, are not limited to such a connection between the housing 41 and the support sleeve 46, and thus, may encompass other connections that permit practice of the embodiments.

The support sleeve 46 may be sized and shaped to receive the proximal end 21 of the support member 20 in an interference fit connection to permanently or removably attach the power module 40 to the support member 20. Embodiments, however, are not limited to such a connection via connection sleeve 46, and thus, may encompass other types of connections that permit practice of the embodiments. For example, the connection may be formed by threaded attachment between the proximal end 21 of the support member 20 and the support sleeve 46.

In the example illustrated in FIGS. 2, 3, 5, and 11, the decorative light module 50 comprises a first decorative luminary 51 that may be connected to a second decorative luminary 52. The first decorative luminary 52 may have one or more light sources 53 to emit light, and the second decorative luminary 52 may have one or more light sources 54 to emit light. In accordance with embodiments, each light source 53, 54 may comprise, for example, light emitting diodes (LED), a reflective bulb, an incandescent bulb, or a combination thereof.

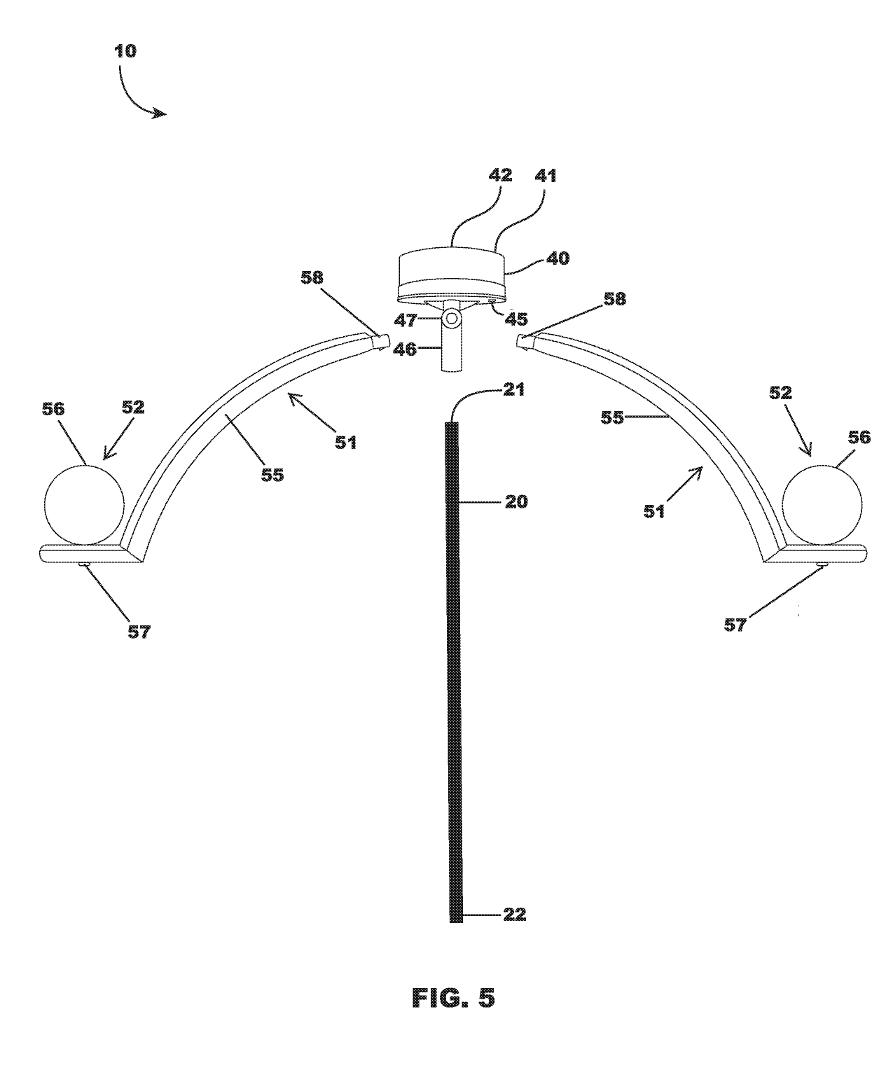

In the example illustrated in FIG. 5, the first decorative luminary 51 may comprise one or more support arms 55 that extend outwardly from a corresponding connection interface 48 of the housing 41. The shape and size of each support arm 55 may vary, so long as the weight of the support arms 55 are distributed in a manner that permit the support arms 55 to balance about the connection point 47. For example, in one embodiment, the weight of the support arms 55 balances evenly atop the connection point 47 when the support arms 55 are respectively received by an electrical interface connector 49 at the connection interface 48 of the housing 41.

A proximal end 58 of the support arm 55 may mechanically connect the support arm 55 at the connection interface 48 of the housing 41 to thereby establish an electrical connection between the light sources 53, 54 and the power module 40. The connection interface 48 is sized and shaped to receive the proximal end 43 of the support member 20 in an interference fit connection to permanently or removably attach the support arm 55 to the power module 40. Embodiments, however, are not limited to such a connection, and thus, may encompass other types of connections that permit practice of the embodiments.

Each support arm 55 has one or more light sources 53 arranged thereon or therein to thereby illuminate the support arm 55 with light L (FIG. 8). The light source(s) 53 may be arranged to extend along, for example, a partial or full length of a corresponding support arm 55. In order to facilitate the illumination of light by the light sources 53 through the support arm 55, the support arm 55 may be composed, at least partially, of a transparent material such as, for example, plastic or a composite. In accordance with embodiments, the overall number of support arms 55 may numerically correspond to the number of connection interfaces 48 located at the housing 41. In the illustrated embodiment, although the support arms 55 are symmetrical to each other, embodiments are not limited thereto, and thus, the support arms 55 may be arranged to be asymmetrical with respect to each other. Although the illustrated embodiment features the first decorative luminary 51 as a support arm 55, embodiments are not limited thereto, and may have any decorative configuration or design that will fall within the spirit and scope of the principles of this disclosure. Alternatively, embodiments may include support arm(s) 55 that do not support any decorative elements thereon.

The second decorative luminary 52 may comprise one or more spherical member(s) 56 supported by a corresponding support arm 55 at a distal end thereof. The second decorative luminary 50 may be connected (either removeably or permanently) at one or more connection regions via a mechanical connector 57. In that way, the spherical member(s) 56 may be supported on a corresponding support arm 55. The connection of the spherical member 56 may also occur, for example, via adhesive, weld, etc. Alternatively, the spherical member 56 may be affixed to a corresponding support arm 55 via screw, clip, etc.

Each spherical member 56 has one or more light sources 54 arranged thereon or therein to thereby illuminate the spherical member 56 with light L (FIG. 8). To facilitate the illumination of light by the light sources 54 through the spherical member 56, the spherical member 56 may be composed, at least partially, of a transparent material such as, for example, plastic or a composite. The light source(s) 54 may comprise, for example, light emitting diodes (LED), a reflective bulb, an incandescent bulb, or combinations thereof. Although the illustrated embodiment features the second decorative luminaries 52 as spherical members 56, embodiments are not limited thereto, and thus, the second decorative luminaries 52 may have any decorative configuration or design that will fall within the spirit and scope of the principles of this disclosure.

The second decorative luminary 52 may be incorporated anywhere along the length of a corresponding support arm 55. The second decorative luminary 52 may be composed of a transparent material so that the light emitted by the light sources 54 illuminates through the second decorative luminary 52. Examples of such decorative elements include, orbs, figurines, dangling emblems, and/or decorative weights made of any number of materials. The decorative elements are not limited to the examples provided herein, (for purposes of are illustrative only), and thus, may include an unlimited number of second decorative luminaries 52.

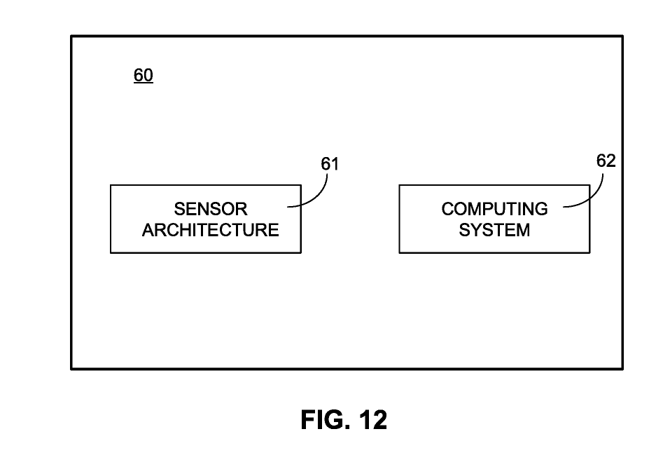

In the example illustrated in FIG. 12, the control module 60 may be in electric communication, via wired communication or wireless communication (e.g., Ethernet, Bluetooth®, Wi-Fi®, WiMAX, LTE, etc.), with the power module 40 and/or the decorative light module 50 to selectively control the light sources 53, 54. For example, the control module 60 may selectively control the light sources 53, 54 in response to the detected spatial positioning of the housing 41 relative to a reference point. Such a reference point may comprise, for example, the support member 20, the support surface of the light system 10, an elevated support point of the light system 10, etc.

In this regard, the control module 60 may comprise sensor architecture 61 (e.g., gravity, tilting, etc.) configured to detect pivoting of the housing 41 relative to the reference point when the housing 41 moves between a stationary positon and a pivoting position. Movement of the housing 41 via a force F may occur selectively via a user (e.g., manually touch or remote control via a controller) or involuntary, such as, for example, by receipt of an outside force (e.g., wind, etc.) by any relative component of the light system 10 that causes pivoting of the housing 41.

The sensing architecture 61 may comprise, for example, one or more sensor devices such as, for example, tilt sensors. Embodiments, however, are not limited thereto, and may reasonably encompass any sensor device that permits practice of the embodiments. To detect pivoting of the housing 41, the sensor devices may be arranged locally within the housing 41. Embodiments, however, are not limited thereto, and may reasonably encompass arranging the sensor devices at any location outside of the housing 41 that permits practice of the embodiments.

In accordance with embodiments, the control module 60 is in electric communication with the sensor architecture 61. The control module 60 comprises a computing system 62 that includes a processor and at least one computer readable storage medium to store a set of instructions which, when executed by the computing system 62, causes the control module 60 to selectively control the light sources 53, 54 in response to the detected pivot position of the housing 41.

In accordance with embodiments, control of the light sources 53, 54 by the control module 60 may include one or more of the following: (i) activating and deactivating each individual light source 53, 54, (ii) controlling an illumination intensity or color of each individual light source 53, 54, and (iii) controlling a sequence of illumination of each individual light source 53, 54, (iv) activating and deactivating a selective group of light sources 53, 54, (v) controlling an illumination intensity or color of a selective group of light sources 53, 54, and (vi) controlling a sequence of illumination of a selective group of light sources 53, 54. The control module 60 may also be in electrical communication with a remote controller that permits a user to selectively control the light sources 53, 54 from a remote distance to the light system 10. Although the control module 60 may be arranged within the housing 41, embodiments are not limited thereto, and may reasonably encompass locating the control module 70 at any location outside of the housing 41 that permits practice of the embodiments. Alternatively, in accordance with embodiments, the control module 70 may itself encompass the sensing function of the sensor architecture 61.

In the example illustrated in FIG. 8, in operation, upon a detected pivoting of the housing 41 (and thus, the decorative light module 50) by the sensing device(s), an electric signal is transmitted by the sensor architecture 61 to the control module 60. The control module 60 may then selectively activate and/or deactivate the light sources 53, 54 contemporaneously with the pivoting of the housing 41. The light sources 53, 54 may be controlled by the control module 60 to illuminate light L in a predetermined pattern, or a random pattern that correlates with the respective movement of the support arm(s) 55. When the respective support arm 55 moves in response to a force F exerted on either one of the housing 41, a support arm 55, or a spherical member 56, the light sources 53, 54 are selectively controlled to give the visual appearance that the illuminated light L travels, flows, or moves along each support arm 55 to a corresponding spherical member 56.

For example, if a force F is applied to the left spherical member 56 so as to pivot the housing 41 towards the left, the light sources 53, 54 are then controlled to give the visual appearance of traveling, flowing, or moving from right to left, beginning at the right spherical member 56, then to the right support arm 55, to the left support arm 55, and terminating at the left spherical member 56. Then, as the housing 41 pivots towards the right, the light sources 53, 54 are controlled to give the visual appearance of traveling, flowing, or moving from left to right, beginning at the left spherical member 56, then to the left support arm 55, to the right support arm 55, and terminating at the right spherical member 56. This controlled lighting effect continues until the support arm 55 have come to a complete rest and have resumed a balanced position.

Alternatively or additionally, as the left support arm 55 moves downwardly and the right support arm 55 moves upwardly, the light sources 53, 54 are controlled to give the visual appearance of traveling, flowing, or moving from right to left, beginning at the housing 41 towards the distal end of the left support arm 55, whereas the illuminated light from the upwardly-moving right support arm 55 may appear to travel, flow, or move from the distal end of the right support arm 55 towards the housing 41. The reverse effect happens upon transition of the left support arm 55 to an upward movement and a downward movement of the right support arm 55. This controlled lighting effect continues until the support arm 55 have come to a complete rest and have resumed a balanced position.

Although the light may be selectively controlled to travel, flow, or move simultaneously through each support arm 55, embodiments are not limited thereto. For example, alternatively, in response to a detected pivoting of the housing 41, the control module 60 may selectively control the light sources 53, 54 through one support arm 55 at a time and/or permit continued illumination in one or more parts of the support arm 55 after the support arm 55 comes to a complete rest.

Accordingly, the light sources 53, 54 give the visual appearance of traveling, flowing, or moving from end-to-end of the light system 10 during the pivoting back-and-forth of the housing 41. This “chasing light” effect continues up and down each support arm 55 until the housing 41 is at rest, i.e., discontinues its pivoting movement. When an external force F is exerted on the light system 10, such as, for example, on a support arm 55, the support arms 55 are thrown off balance, like a scale, causing the light apparatus to pivot back and forth. The pivoting incrementally decreases when the force is removed until the support arms 55 rest and resume their balanced position.

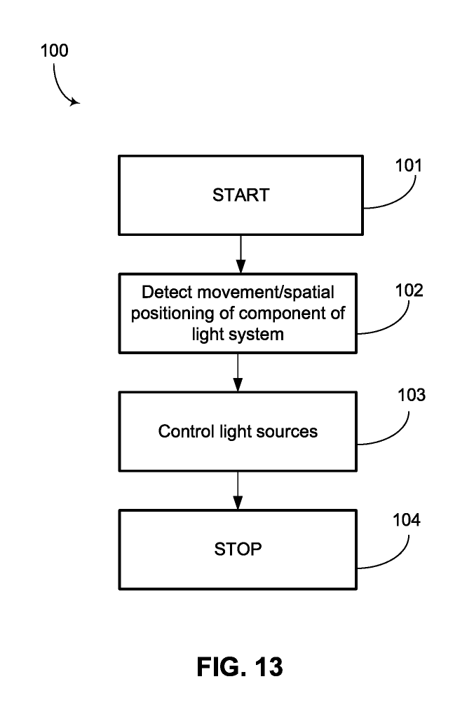

In the example illustrated in FIG. 13, a method 100 for controlling a light apparatus is provided. The method 100 may generally be implemented in the computing system 62 of the control module 60 illustrated in FIG. 12, and which is described herein. In particular, the method 100 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 100 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

As illustrated in the method 100, illustrated processing block 101 provides for starting or activating the light system 10 via, for example, activating the power switch 45 or automatically via the photosensor described herein.

Illustrated processing block 102 provides for detecting movement or spatial positioning of any component of the light system 10 relative to a reference point. This may occur, for example, by detecting the pivoting (about a pivot axis) of the housing 41 relative to the support member 20, the support surface of the light system 10, an elevated support point of the light system 10, etc.

Illustrated processing block 103 provides for controlling, in response to the detecting movement or spatial positioning, the light sources 53, 54. Such control may occur for example, via the power module 40.

In accordance with processing block 103, selectively controlling the one or more light sources comprises controlling at least one of: (i) an illumination intensity or color of the one or more light sources, (ii) a sequence of illumination of the one or more light sources, (iii) an illumination intensity or color of a selective group of the one or more light sources, and (iv) a sequence of illumination of a selective group of the one or more light sources.

In accordance with processing block 103, selectively controlling the one or more light sources comprises activating and deactivating at least one of: (i) the one or more light sources in a predetermined, synchronized manner relative to each other, and (ii) a selective group of the one or more light sources.

In accordance with processing block 103, selectively controlling the one or more light sources comprises at least one of: (i) controlling an illumination intensity or color of the one or more light sources, (ii) controlling a sequence of illumination of the one or more light sources, (iii) controlling an illumination intensity or color of a selective group of the one or more light sources, (iv) controlling a sequence of illumination of a selective group of the one or more light sources, (v) activating and deactivating the one or more light sources in a predetermined, synchronized manner relative to each other, and (vi) activating and deactivating a selective group of the one or more light sources.

Illustrated processing block 104 provides for stopping control of the light sources 53, 54. This may occur, for example, when the housing 41 is at rest, i.e., is no longer pivoting about a pivot axis.

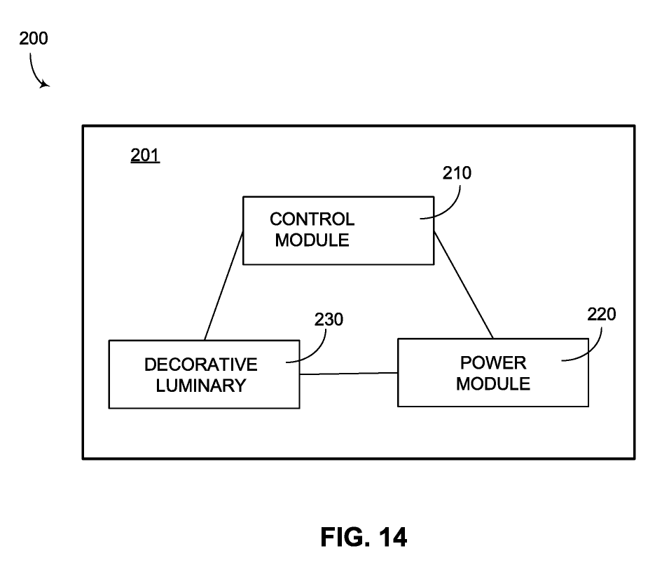

In the example illustrated in FIG. 14, an embodiment of a light apparatus 200 comprises a decorative light module 201 that is to include a power module 220 including a housing configured for movement about a pivot axis between a stationary position and a pivot position, at least one decorative luminary 230 (e.g., the decorative luminary described hereinabove) having one or more light sources to emit light, and a control module 210 in electric communication with the power module 220 and/or the at least one decorative luminary 230. The at least one decorative luminary 230 is configured for connection to the housing at an interface which is to establish electric communication between the power module 220 and the one or more light sources. The control module 210 comprises at least one sensor device to detect a spatial position of the housing relative to the support member. The control module 210 also comprises a computing system in electric communication with the at least one sensor device. The computing system includes a processor, and at least one computer readable storage medium to store a set of instructions which, when executed by the computing system, cause the control module to selectively control, in response to the detected spatial position, the one or more light sources.

### Additional Notes and Examples

Example One may include a light system, comprising: a support member; a power module supported on the support member, the power module including a housing configured for movement about a pivot axis between a stationary position and a pivot position; at least one decorative luminary having one or more light sources to emit light, the at least one decorative luminary being configured for connection to the housing at an interface to establish electric communication between the one or more light sources and the power module; and a control module in electric communication with the power module, the control module including at least one sensor device to detect a spatial position of the housing relative to the support member, and a computing system in electric communication with the at least one sensor device, the computing system having a processor, and at least one computer readable storage medium to store a set of instructions which, when executed by the computing system, cause the control module to selectively control, in response to the detected spatial position, the one or more light sources.

Example 2 may include the light system of Example 1, wherein the power module comprises a solar circuit module with one or more solar panels to collect sunlight energy.

Example 3 may include the light system of Example 1, wherein the at least one decorative luminary is composed at least partially of a transparent material to be illuminated by the one or more light sources.

Example 4 may include the light system of Example 1, further comprising a support sleeve configured to support the housing on the support member at a connection point defining a pivot axis that facilitates movement of the power module about the pivot axis between a stationary position and one or more pivoting positions relative to the support member.

Example 5 may include the light system of Example 1, wherein selectively controlling the one or more light sources comprises activating and deactivating at least one of: the one or more light sources in a predetermined, synchronized manner relative to each other, and a selective group of the one or more light sources.

Example 6 may include the light system of Example 1, wherein selectively controlling the one or more light sources comprises controlling at least one of: an illumination intensity or color of the one or more light sources, a sequence of illumination of the one or more light sources, an illumination intensity or color of a selective group of the one or more light sources, and a sequence of illumination of a selective group of the one or more light sources.

Example 7 may include the light system of Example 1, wherein selectively controlling the one or more light sources comprises at least one of: activating and deactivating the one or more light sources in a predetermined, synchronized manner relative to each other, activating and deactivating a selective group of the one or more light sources, controlling an illumination intensity or color of the one or more light sources, controlling a sequence of illumination of the one or more light sources, controlling an illumination intensity or color of a selective group of the one or more light sources, and controlling a sequence of illumination of a selective group of the one or more light sources.

Example 8 may include the light system of Example 1, wherein the at least one decorative luminary comprises a first decorative luminary extending from the housing and a decorative luminary supported by the first decorative luminary.

Example 9 may include a light apparatus, comprising: a decorative light module including: a power module including a housing configured for movement about a pivot axis between a stationary position and a pivot position, at least one decorative luminary having one or more light sources to emit light, the at least one decorative luminary being configured for connection to the housing at an interface to establish electric communication between the power module and the one or more light sources, and a control module in electric communication with the power module, the control module including at least one sensor device to detect a spatial position of the housing relative to the support member, and a computing system in electric communication with the at least one sensor device, the computing system having a processor, and at least one computer readable storage medium to store a set of instructions which, when executed by the computing system, cause the control module to selectively control, in response to the detected spatial position, the one or more light sources.

Example 10 may include the light apparatus of Example 9, wherein the power module comprises a solar circuit module with one or more solar panels to collect solar energy.

Example 11 may include the light apparatus of Example 9, wherein the at least one decorative luminary is composed at least partially of a transparent material to be illuminated by the one or more light sources.

Example 12 may include the light apparatus of Example 9, further comprising a support sleeve configured to support the housing at a connection point defining a pivot axis that facilitates movement of the power module about the pivot axis between a stationary position and one or more pivoting positions.

Example 13 may include the light apparatus of Example 9, wherein selectively controlling the one or more light sources comprises activating and deactivating at least one of: the one or more light sources in a predetermined, synchronized manner relative to each other, and a selective group of the one or more light sources.

Example 14 may include the light apparatus of Example 9, wherein selectively controlling the one or more light sources comprises controlling at least one of: an illumination intensity or color of the one or more light sources, a sequence of illumination of the one or more light sources, an illumination intensity or color of a selective group of the one or more light sources, and a sequence of illumination of a selective group of the one or more light sources.

Example 15 may include the light apparatus of Example 9, wherein selectively controlling the one or more light sources comprises at least one of: activating and deactivating the one or more light sources in a predetermined, synchronized manner relative to each other, activating and deactivating a selective group of the one or more light sources, controlling an illumination intensity or color of the one or more light sources, controlling a sequence of illumination of the one or more light sources, controlling an illumination intensity or color of a selective group of the one or more light sources, and controlling a sequence of illumination of a selective group of the one or more light sources.

Example 16 may include the light apparatus of Example 9, wherein the at least one decorative luminary comprises a first decorative luminary extending from the housing and a decorative luminary supported by the first decorative luminary.

Example 17 may include a method of controlling a light apparatus, comprising: detecting a spatial positioning of a housing of the light apparatus relative to a reference point; and selectively controlling, in response to the detecting spatial positioning, one or more light sources of the light apparatus.

Example 18 may include the method of Example 17, wherein selectively controlling the one or more light sources comprises activating and deactivating at least one of: the one or more light sources in a predetermined, synchronized manner relative to each other, and a selective group of the one or more light sources.

Example 19 may include the method of Example 17, wherein selectively controlling the one or more light sources comprises controlling at least one of: an illumination intensity or color of the one or more light sources, a sequence of illumination of the one or more light sources, an illumination intensity or color of a selective group of the one or more light sources, and a sequence of illumination of a selective group of the one or more light sources.

Example 20 may include the method of Example 17, wherein selectively controlling the one or more light sources comprises at least one of: activating and deactivating the one or more light sources in a predetermined, synchronized manner relative to each other, activating and deactivating a selective group of the one or more light sources, controlling an illumination intensity or color of the one or more light sources, controlling a sequence of illumination of the one or more light sources, controlling an illumination intensity or color of a selective group of the one or more light sources, and controlling a sequence of illumination of a selective group of the one or more light sources.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

This written description uses examples to disclose the invention, including the preferred embodiments, and also to enable any person skilled in the art to practice the invention, including making and using any devices or systems and performing any incorporated methods. The patentable scope of embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, may be mixed and matched by one of ordinary skill in the art to construct additional embodiments and techniques in accordance with principles of this application.

### LIST OF REFERENCE SYMBOLS

10 Light System

20 Support member

21 Proximal end of support member

22 Distal end of support member

30 Light apparatus

40 Power module

41 Power module housing

42 Solar panel(s)

43 Circuit Board

44 Battery

45 Power switch

46 Support Sleeve

47 Connection point

48 Connection interface

49 Electrical interface connector

50 Decorative Light Module

51 1^{st} decorative luminary

52 2^{nd} decorative luminary

53 Light source(s) (1^{st} decorative luminary)

54 Light source(s) (2^{nd} decorative luminary)

55 Support arms

56 Spherical member

57 Connector

58 Proximal end of support arm

60 Control module

61 Sensor architecture

62 Computing system

What is claimed is:

1. A light system, comprising:
a support member;
a power module supported on the support member, the power module including a housing configured for movement about a pivot axis between a stationary position and a pivot position;
at least one decorative luminary having one or more light sources to emit light, the at least one decorative luminary being configured for connection to the housing at an interface to establish electric communication between the one or more light sources and the power module; and
a control module in electric communication with the power module, the control module including at least one sensor device to detect a spatial position of the housing relative to the support member, and a computing system in electric communication with the at least one sensor device, the computing system having a processor, and at least one computer readable storage medium to store a set of instructions which, when executed by the computing system, cause the control module to selectively control, in response to the detected spatial position, the one or more light sources.

2. The light system of claim 1, wherein the power module comprises a solar circuit module with one or more solar panels to collect sunlight energy.

3. The light system of claim 1, wherein the at least one decorative luminary is composed at least partially of a transparent material to be illuminated by the one or more light sources.

4. The light system of claim 1, further comprising a support sleeve configured to support the housing on the support member at a connection point defining a pivot axis that facilitates movement of the power module about the pivot axis between a stationary position and one or more pivoting positions relative to the support member.

5. The light system of claim 1, wherein selectively controlling the one or more light sources comprises activating and deactivating at least one of:
the one or more light sources in a predetermined, synchronized manner relative to each other, and
a selective group of the one or more light sources.

6. The light system of claim 1, wherein selectively controlling the one or more light sources comprises controlling at least one of:
an illumination intensity or color of the one or more light sources,
a sequence of illumination of the one or more light sources,
an illumination intensity or color of a selective group of the one or more light sources, and
a sequence of illumination of a selective group of the one or more light sources.

7. The light system of claim 1, wherein selectively controlling the one or more light sources comprises at least one of:
activating and deactivating the one or more light sources in a predetermined, synchronized manner relative to each other,
activating and deactivating a selective group of the one or more light sources,
controlling an illumination intensity or color of the one or more light sources,
controlling a sequence of illumination of the one or more light sources,
controlling an illumination intensity or color of a selective group of the one or more light sources, and
controlling a sequence of illumination of a selective group of the one or more light sources

8. The light system of claim 1, wherein the at least one decorative luminary comprises a first decorative luminary extending from the housing and a decorative luminary supported by the first decorative luminary.

9. A light apparatus, comprising:
a decorative light module including:
a power module including a housing configured for movement about a pivot axis between a stationary position and a pivot position,
at least one decorative luminary having one or more light sources to emit light, the at least one decorative luminary being configured for connection to the housing at an interface to establish electric communication between the power module and the one or more light sources, and
a control module in electric communication with the power module, the control module including at least one sensor device to detect a spatial position of the housing relative to the support member, and a computing system in electric communication with the at least one sensor device, the computing system having a processor, and at least one computer readable storage medium to store a set of instructions which, when executed by the computing system, cause the control module to selectively control, in response to the detected spatial position, the one or more light sources.

10. The light apparatus of claim 9, wherein the power module comprises a solar circuit module with one or more solar panels to collect solar energy.

11. The light apparatus of claim 9, wherein the at least one decorative luminary is composed at least partially of a transparent material to be illuminated by the one or more light sources.

12. The light apparatus of claim 9, further comprising a support sleeve configured to support the housing at a connection point defining a pivot axis that facilitates movement of the power module about the pivot axis between a stationary position and one or more pivoting positions.

13. The light apparatus of claim 9, wherein selectively controlling the one or more light sources comprises activating and deactivating at least one of:
the one or more light sources in a predetermined, synchronized manner relative to each other, and
a selective group of the one or more light sources.

14. The light apparatus of claim 9, wherein selectively controlling the one or more light sources comprises controlling at least one of:
an illumination intensity or color of the one or more light sources,
a sequence of illumination of the one or more light sources,
an illumination intensity or color of a selective group of the one or more light sources, and
a sequence of illumination of a selective group of the one or more light sources.

15. The light apparatus of claim 9, wherein selectively controlling the one or more light sources comprises at least one of:
activating and deactivating the one or more light sources in a predetermined, synchronized manner relative to each other,
activating and deactivating a selective group of the one or more light sources,
controlling an illumination intensity or color of the one or more light sources,
controlling a sequence of illumination of the one or more light sources,
controlling an illumination intensity or color of a selective group of the one or more light sources, and
controlling a sequence of illumination of a selective group of the one or more light sources.

16. The light apparatus of claim 9, wherein the at least one decorative luminary comprises a first decorative luminary extending from the housing and a decorative luminary supported by the first decorative luminary.

17. A method of controlling a light apparatus, comprising:
detecting a spatial positioning of a housing of the light apparatus relative to a reference point; and
selectively controlling, in response to the detecting spatial positioning, one or more light sources of the light apparatus.

18. The method of claim 17, wherein selectively controlling the one or more light sources comprises activating and deactivating at least one of:
the one or more light sources in a predetermined, synchronized manner relative to each other, and
a selective group of the one or more light sources.

19. The method of claim 17, wherein selectively controlling the one or more light sources comprises controlling at least one of:
an illumination intensity or color of the one or more light sources,
a sequence of illumination of the one or more light sources,
an illumination intensity or color of a selective group of the one or more light sources, and
a sequence of illumination of a selective group of the one or more light sources.

20. The method of claim 17, wherein selectively controlling the one or more light sources comprises at least one of:
activating and deactivating the one or more light sources in a predetermined, synchronized manner relative to each other,
activating and deactivating a selective group of the one or more light sources,
controlling an illumination intensity or color of the one or more light sources,
controlling a sequence of illumination of the one or more light sources,
controlling an illumination intensity or color of a selective group of the one or more light sources, and
controlling a sequence of illumination of a selective group of the one or more light sources.
